(19) United States
(12) Patent Application Publication
(10) Pub. No.: US 2023/0102883 A1
(43) Pub. Date: Mar. 30, 2023

(54) CELL PHONE CASE FOR PROTECTING HINGE

(71) Applicant: ISPEAKER CO., LTD., Goyang-Si (KR)

(72) Inventor: Young Suk CHUNG, Goyang-Si (KR)

(21) Appl. No.: 17/561,692

(22) Filed: Dec. 23, 2021

(30) Foreign Application Priority Data
Sep. 13, 2021 (KR) 10-2021-0121756

(51) Int. Cl. H04M 1/02; H04B 1/3888

(52) U.S. Cl. CPC H04M 1/0214; H04B 1/3888

(57) ABSTRACT

Provided is a cell phone case for protecting a hinge. The cell phone case includes a first cover unit which is provided with a first peripheral part to be coupled to a first body of a foldable mobile phone, a second cover unit which is provided with a second peripheral part to be coupled to a second body of the foldable mobile phone, faces the first cover unit, and independent from the first cover unit, a connection unit which includes a flexible material to enable bending deformation and elastic restoration, extends from a first cover unit-side edge of the second cover unit in a direction in which the first cover unit and the second cover unit face each other, and is provided with a hole at an end thereof, and a third cover unit which includes a rigid material to maintain the original form, and is provided with a magnetic member to be attached to and detached from the hinge of the foldable cell phone and a snap member to be coupled to the hole of the connection unit. The cell phone case may simplify the structure and stably protect the hinge of the foldable cell phone.

### CROSS-REFERENCE TO RELATED APPLICATION

This application claims priority to Korean Patent Application No. 10-2021-0121756 filed on Sep. 13, 2021 and all the benefits accruing therefrom under 35 U.S.C. §119, the contents of which are incorporated by reference in their entirety.

### BACKGROUND

The present disclosure relates to a cell phone case for protecting a hinge, and more particularly, to a cell phone case capable of simplifying a structure and stably protecting a hinge of a foldable cell phone.

Recently, cell phones have wireless Internet, high-definition displays, high-pixel cameras, and large-area touch screens in addition to calling functions, and thus form high prices. Thus, in order to protect cell phones from impact due to the carelessness of a user, various types of cell phone cases have been used.

The cell phone cases have structures that match cell phones in which the cell phone cases are used. For example, cell phone cases used in bar-type cell phones represented by “Galaxy S” series and “iPhone” series have structures that cover the rear surfaces or side surfaces of the relevant cell phones.

Meanwhile, as high-quality images and high-end games may be subscribed by using cell phones recently, demands for large screens increase. Accordingly, foldable cell phones using flexible displays have been developed.

The foldable cell phone developed recently have different structures from the existing bar-type cell phones, and thus, cases for the foldable cell phones need to be newly developed. However, cases for foldable cell phones presented so far have merely a structure in which cases for bar-type cell phones according to the related art are simply connected mechanically. Thus, connection structures of parts for covering hinges of the foldable cell phones are complicated and vulnerable to damages due to accumulation of fatigue.

### SUMMARY

The present disclosure provides a cell phone case capable of simplifying a structure.

The present disclosure also provides a cell phone case capable of stably protecting a hinge of a foldable cell phone.

In accordance with an exemplary embodiment, a cell phone case for protecting a hinge includes: a first cover unit which is provided with a first peripheral part to be coupled to a first body of a foldable mobile phone; a second cover unit which is provided with a second peripheral part to be coupled to a second body of the foldable mobile phone, faces the first cover unit, and independent from the first cover unit; a connection unit which includes a flexible material to enable bending deformation and elastic restoration, extends from a first cover unit-side edge of the second cover unit in a direction in which the first cover unit and the second cover unit face each other, and is provided with a hole at an end thereof; and a third cover unit which includes a rigid material to maintain the original form, and is provided with a magnetic member to be attached to and detached from the hinge of the foldable cell phone and a snap member to be coupled to the hole of the connection unit.

The first cover unit may include a first inner cover made of a flexible material to be coupled to the first body and a first outer cover made of a rigid material to maintain a shape of the first inner cover, and the first peripheral part may be provided on three edges of the first inner cover except for a second cover unit-side edge among the four edges.

A first opening may be provided in each of the first inner cover and the first outer cover to expose an external display on a rear surface of the first body.

The second cover unit may include a second inner cover made of a flexible material to be coupled to the second body and a second outer cover made of a rigid material to maintain a shape of the second inner cover, and the connection unit may extend from a first cover unit-side edge of the second inner cover among the four edges, and the second peripheral part may be provided on the remaining three edges except for the first cover unit-side edge.

A second opening may be provided in each of the second inner cover and the second outer cover to expose a rear camera on a rear surface of the second body.

The connection unit may be provided in plurality, and the connection units may be arrayed along a direction, in which the hinge extends, and protected from the outside by being arranged between the third cover unit and the hinge, and the number of snap members of the third cover unit may be equal to the number of connection units, and the snap members may be provided on a front surface of the third cover unit and arrayed along the direction in which the hinge extends.

An inner diameter of the hole of the connection unit may be less than an end-side diameter of the snap member of the third cover unit and greater than or equal to a base-side diameter of the snap member.

The third cover unit may include: a fixed edge which extends in a direction, in which the hinge extends, and maintains contact with the first cover unit-side edge of the second cover unit when the foldable cell phone folds and unfolds; a free edge which extends in the direction, in which the hinge extends, contacts a second cover unit-side edge of the first cover unit when the foldable cell phone folds, and is separated from the second cover unit-side edge of the first cover unit when the foldable cell phone unfolds; a first connection edge which connects one end of the fixed edge and one end of the free edge in a direction in which the first cover unit and the second cover unit face each other; a second connection edge which connects the other end of the fixed edge and the other end of the free edge in the direction in which the first cover unit and the second cover unit face each other; and a cover shell surrounded by the fixed edge, the free edge, the first connection edge, and the second connection edge.

The cover shell may be formed such that a central portion of a front surface thereof is recessed to accommodate the magnetic member and the snap member.

Each of the magnetic member and the snap member may be provided in plurality, and the magnetic members and the snap members may be arrayed in the central portion of the front surface of the cover shell in the direction in which the hinge extends.

The plurality of the snap members may be arranged between the plurality of the magnetic members.

The plurality of magnetic members and the plurality of snap members may contact the hinge when the foldable cell phone folds, and have lengths not to protrude forward more than the fixed edge and the free edge when the foldable cell phone unfolds.

The cover shell may cover the hinge of the foldable cell phone by using a magnetic force of the magnetic member when the foldable cell phone folds, and cover a gap between the first cover unit and the second cover unit as overlapping with the first cover unit by using an elastic restoring force due to bending deformation of the connection unit when the foldable cell phone unfolds.

In accordance with another exemplary embodiment, a cell phone case is to protect a bendable side surface portion of a foldable cell phone which is used in a state where a first body and a second body are bent to face each other or spread, and the cell phone case includes: a rear surface protection unit coupled to at least one of the first body or the second body of the foldable cell phone; and a side surface protection unit connected to the rear surface protection unit to protect a bendable side surface of the foldable cell phone, wherein the rear surface protection unit is provided with a cover connection part having an insertion hole, and the side surface protection unit includes a snap member to be coupled to the insertion hole of the cover connection part and is connected to the rear surface protection unit.

In accordance with yet another exemplary embodiment, a cell phone case is to protect a bendable side surface portion of a foldable cell phone which is used in a state where a first body and a second body are bent to face each other or spread, and the cell phone case includes: a rear surface protection unit coupled to at least one of the first body or the second body of the foldable cell phone; and a side surface protection unit connected to the rear surface protection unit to protect a bendable side surface of the foldable cell phone, wherein the side surface protection unit is provided with a cover connection part having an insertion hole, and the rear surface protection unit includes a snap member to be coupled to the insertion hole of the cover connection part and is connected to the side surface protection unit.

The side surface protection unit may include a side surface connection part attached to and detached from the bendable side surface of the foldable cell phone.

The side surface connection part may include a magnetic member to be attached to and detached from a hinge of the foldable cell phone.

### BRIEF DESCRIPTION OF THE DRAWINGS

Exemplary embodiments can be understood in more detail from the following description taken in conjunction with the accompanying drawings, in which:

FIG. 1 is a view showing a folding state of a foldable cell phone to which a cell phone case capable of protecting a hinge according to an embodiment of the present disclosure is mounted;

FIG. 2 is a view showing a state in which the foldable cell phone is removed from the cell phone case capable of protecting a hinge illustrated in FIG. 1;

FIG. 3 is a view showing an unfolding state of the foldable cell phone to which the cell phone case capable of protecting a hinge according to an embodiment of the present disclosure is mounted;

FIG. 4 is a view showing a state in which the foldable cell phone is removed from the cell phone case capable of protecting a hinge illustrated in FIG. 3;

FIG. 5 is a view showing a state when the cell phone case capable of protecting a hinge illustrated in FIG. 4 is viewed from the rear;

FIG. 6 is a view showing a state in which the cell phone case capable of protecting a hinge according to an embodiment of the present disclosure is entirely disassembled;

FIG. 7 is a view showing a state in which an inner cover of a second cover unit is coupled to a third cover unit by a connection unit of the cell phone case capable of protecting a hinge illustrated in FIG. 6;

FIG. 8 is a schematic view of a first inner cover of a first cover unit according to an embodiment of the present disclosure;

FIG. 9 is a schematic view of a first outer cover of the first cover unit according to an embodiment of the present disclosure;

FIG. 10 is a view illustrating a second inner cover of a second cover unit and a connection unit extending therefrom according to an embodiment of the present disclosure;

FIG. 11 is a schematic view of a second outer cover of the second cover unit according to an embodiment of the present disclosure;

FIG. 12 is a schematic view of a third cover unit according to an embodiment of the present disclosure; and

FIGS. 13 to 17 are views showing a foldable cell phone to which a cell phone case capable of protecting a hinge according to a modified example of the present disclosure is mounted.

### DETAILED DESCRIPTION OF EMBODIMENTS

Hereinafter, embodiments of the present disclosure will be described in detail with reference to the accompanying drawings. The present disclosure may, however, be embodied in different forms and should not be construed as limited to the embodiments set forth herein. Rather, the embodiments of the present disclosure are provided so that this disclosure will be thorough and complete, and will fully convey the scope of the present disclosure to those skilled in the art. The drawings may be exaggeratedly illustrated so as to describe the embodiment of the present disclosure, parts irrelevant to the description will be omitted from the drawings, and like reference numerals in the drawings refer to like elements.

Hereinafter, an embodiment of the present disclosure will be described with reference to the drawings.

### 1. Cell Phone Case Capable of Protecting a Hinge According to an Embodiment of the Present Disclosure

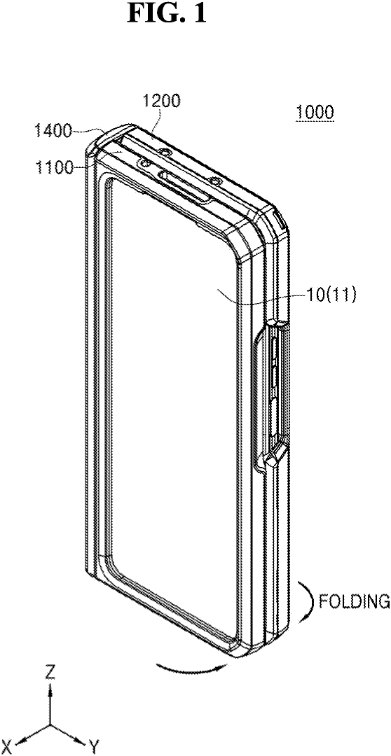

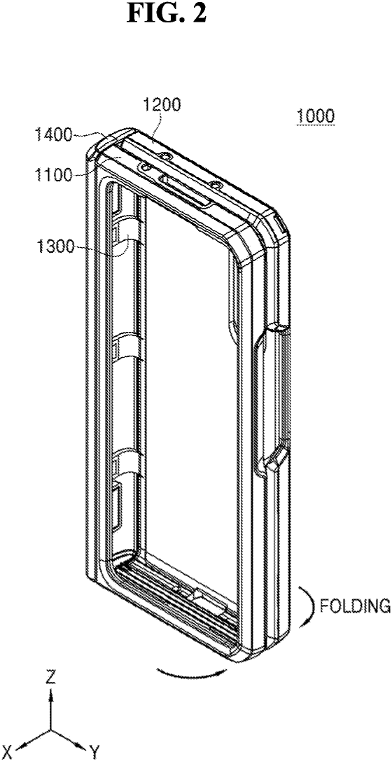

FIG. 1 is a view showing a folding state of a foldable cell phone to which a cell phone case capable of protecting a hinge according to an embodiment of the present disclosure is mounted. FIG. 2 is a view showing a state in which the foldable cell phone is removed from the cell phone case capable of protecting a hinge illustrated in FIG. 1.

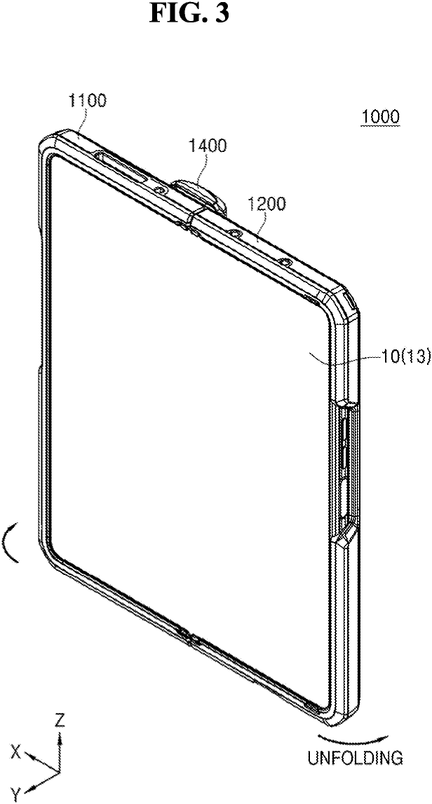

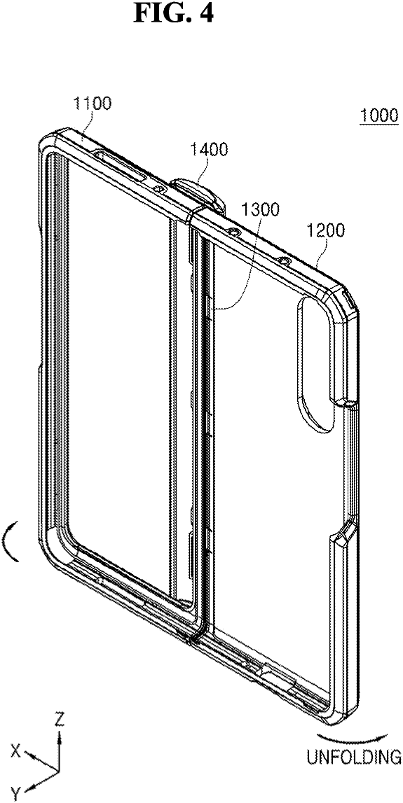

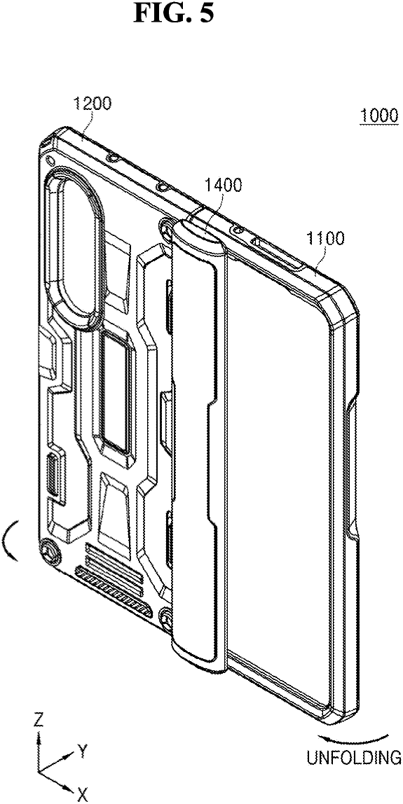

Also, FIG. 3 is a view showing an unfolding state of the foldable cell phone to which the cell phone case capable of protecting a hinge according to an embodiment of the present disclosure is mounted. FIG. 4 is a view showing a state in which the foldable cell phone is removed from the cell phone case capable of protecting a hinge illustrated in FIG. 3. Also, FIG. 5 is a view showing a state when the cell phone case capable of protecting a hinge illustrated in FIG. 4 is viewed from the rear.

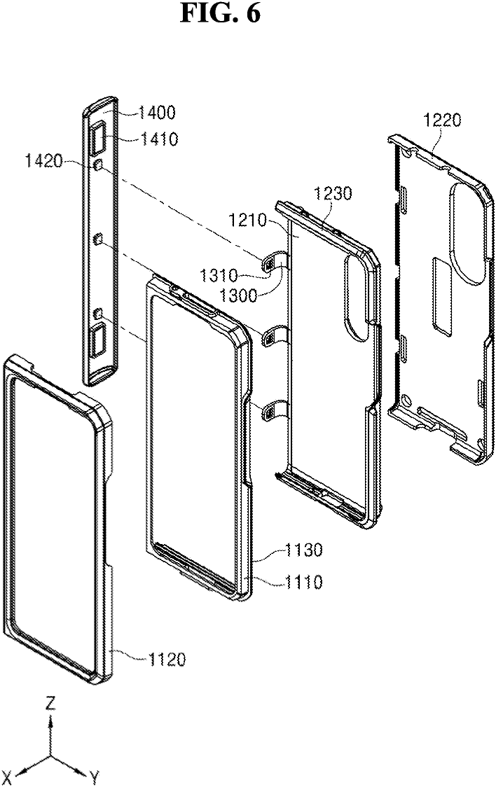

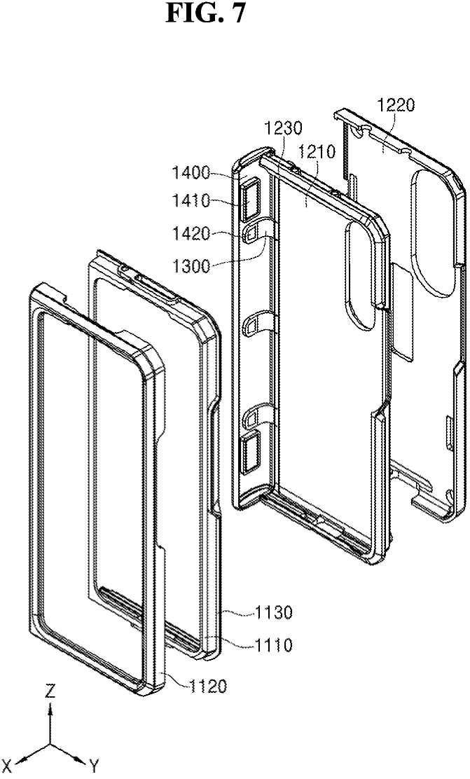

Also, FIG. 6 is a view showing a state in which the cell phone case capable of protecting a hinge according to an embodiment of the present disclosure is entirely disassembled. FIG. 7 is a view showing a state in which an inner cover of a second cover unit is coupled to a third cover unit by a connection unit of the cell phone case capable of protecting a hinge illustrated in FIG. 6.

Referring to FIGS. 1 to 7, a cell phone case 1000 capable of protecting a hinge according to an embodiment of the present disclosure may be a cell phone case 1000 coupled to a foldable cell phone 10 and capable of protecting the foldable cell phone 10. Surely, the cell phone case 1000 capable of protecting a hinge according to an embodiment of the present disclosure may be used as a case for various types of foldable display devices (not shown) in addition to the foldable cell phone 10.

The foldable cell phone 10 may include a first body and a second body which are foldable and unfoldable about a hinge. A main display 13 may be provided in the front surfaces of the first body and the second body. Here, the front surfaces of the first body and the second body may be the surfaces facing each other in the first body and the second body when the foldable cell phone 10 folds. An external display 11 may be provided in the rear surface of the first body. The hinge may protrude rearward from the first body and the second body when the foldable cell phone 10 folds, and may be accommodated inside the first body and the second body when the foldable cell phone 10 unfolds.

The cell phone case 1000 for protecting the hinge includes: a first cover unit 1100 which is provided with a first peripheral part 1130 to be coupled to the first body of the foldable mobile phone 10; a second cover unit 1200 which is provided with a second peripheral part 1230 to be coupled to the second body of the foldable mobile phone 10, faces the first cover unit 1100, and independent from the first cover unit 1100; a connection unit 1300 which includes a flexible material to enable bending deformation and elastic restoration, extends from a first cover unit-side edge of the second cover unit 1200 in a direction in which the first cover unit 1100 and the second cover unit 1200 face each other, and is provided with a hole 1310 at an end thereof; and a third cover unit 1400 which includes a rigid material to maintain the original form, and is provided with a magnetic member 1410 to be attached to and detached from the hinge of the foldable cell phone 10 and a snap member 1420 to be coupled to the hole 1310 of the connection unit 1300.

Here, the flexible material may be a polymer material. Particularly, the flexible material may be thermoplastic polyurethane (TPU). Surely, the thermoplastic polyurethane is one example of the flexible material, and the types of the flexible material may be diverse.

Also, the rigid material may be thermoplastic plastics. Particularly, the rigid material may be polycarbonate (PC). Similarly, the polycarbonate is one example of the rigid material, and the types of the rigid material may be diverse.

The direction in which the first cover unit 1100 faces the second cover unit 1200 may be a left-right direction X. The direction in which the hinge extends may be an up-down direction Z. The direction, which crosses the direction in which the hinge extends, may be a front-rear direction Y. The definitions of these directions may be varied according to orientations of the cell phone case 1000. Hereinafter, the specific structure of the cell phone case 1000 will be described on the basis of a state in which the cell phone case 1000 stands in the up-down direction Z and folds as illustrated in FIGS. 1 and 2.

### 1.1. First Cover Unit 1100

The first cover unit 1100 may be fitted and coupled to the first body of the foldable cell phone 10 in the form surrounding the edges of the first body of the foldable cell phone 10, and accordingly, the first body of the foldable cell phone 10 may be protected from external impact.

The first cover unit 1100 may include a first inner cover 1110 made of a flexible material to be coupled to the first body of the foldable cell phone 10, a first outer cover 1120 made of a rigid material to maintain a shape of the first inner cover 1110, and a first peripheral part 1130 provided on three edges of the first inner cover 1110 except for a second cover unit-side edge among the four edges. A first opening is provided in each of the first inner cover 1110 and the first outer cover 1120 to expose the external display 11 on the rear surface of the first body of the foldable cell phone 10.

### 1.1.1. First Inner Cover 1110

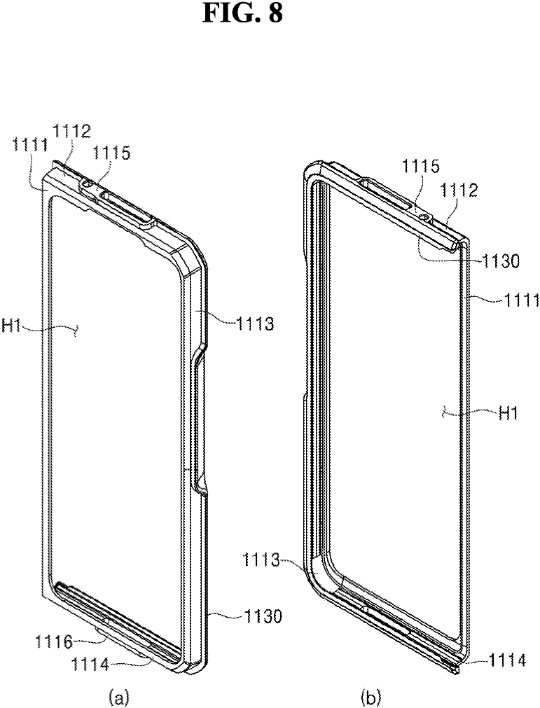

(a) and (b) of FIG. 8 are schematic views of the first inner cover of the first cover unit according to an embodiment of the present disclosure.

Referring to FIGS. 6 and 8, the first inner cover 1110 may include: a first inner cover frame 1111 on which a rim portion of the rear surface of the first body of the foldable cell phone 10 may be seated; a plurality of bent parts 1112, 1113, and 1114 provided on three edges of the first inner cover frame 1111 except for a second cover unit-side edge among the four edges; and a plurality of connect holes 1115 and 1116 which are formed in the first bent part 1112 and the second bent part 1113, respectively, which among the plurality of bent parts 1112, 1113, and 1114, extend in the front-rear direction Y.

The first inner cover frame 1111 may have a quadrangular frame shape. The first inner cover frame 1111 may have a first opening H1 formed at a central portion. The first inner cover frame 1111 may have an area capable of covering the rim portion of the rear surface of the first body of the foldable cell phone 10. The plurality of bent parts 1112, 1113, and 1114 may be bent from the above-described three edges of the first inner cover frame 1111 in the left-right direction so as to contact the outline of the first body of the foldable cell phone 10. The third bent part 1114 among the plurality of bent parts 1112, 1113, and 1114 may extend in the up-down direction Z. The plurality of connect holes 1115 and 1116 may allow terminals provided on the outline of the first body of the foldable cell phone 10 to be exposed in the up-down direction Z.

### 1.1.2. First Outer Cover 1120

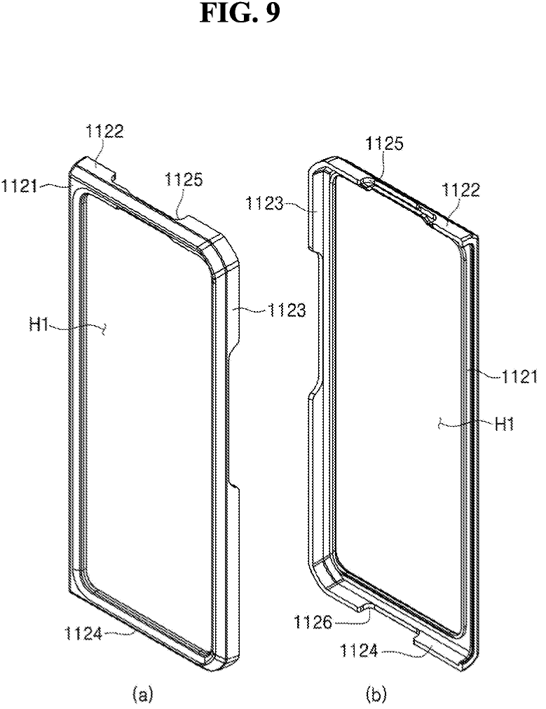

(a) and (b) of FIG. 9 are schematic views of the first outer cover of the first cover unit according to an embodiment of the present disclosure.

Referring to FIGS. 6 and 9, the first outer cover 1120 may include: a first outer cover frame 1121 on which the first inner cover frame 1111 may be seated; a plurality of side walls 1122, 1123, and 1124 provided on three edges of the first outer cover frame 1121 except for a second cover unit-side edge among the four edges; and a plurality of connect grooves 1125 and 1126 which are formed in the first side wall 1122 and the second side wall 1123, respectively, which among the plurality of side walls 1122, 1123, and 1124, extend in the front-rear direction Y.

The first outer cover frame 1121 may have the same shape as the first inner cover frame 1111. The first outer cover frame 1121 may have a first opening H1 formed at a central portion. The first outer cover frame 1121 may support the first inner cover frame 1111. The plurality of side walls 1122, 1123, and 1124 may be bent from the above-described three edges of the first outer cover frame 1121 in the left-right direction so as to be fitted and coupled to the plurality of bent parts 1112, 1113, and 1114, respectively. Here, the third side wall 1124 among the plurality of side walls 1122, 1123, and 1124 may extend in the up-down direction Z. The plurality of connect holes 1115 and 1116 may be fitted and coupled to the plurality of connect grooves 1125 and 1126, respectively.

### 1.1.3. First Peripheral Part 1130

The first peripheral part 1130 may be formed on ends of the first bent part 1112, the second bent part 1113, and the third bent part 1114. The first peripheral part 1130 may protrude from the ends of the first bent part 1112, the second bent part 1113, and the third bent part 1114 in the up-down direction Z and the front-rear direction Y so as to contact the rim portion of the front surface of the first body of the foldable cell phone 10. As the first peripheral part 1130 is locked to the rim portion of the front surface of the first body of the foldable cell phone 10, the first cover unit 1100 may be coupled to the first body of the foldable cell phone 10.

### 1.2. Second Cover Unit 1200

The second cover unit 1200 may be fitted and coupled to the second body of the foldable cell phone 10 in the form surrounding the edges and the rear surface of the second body of the foldable cell phone 10, and accordingly, the second body of the foldable cell phone 10 may be protected from external impact.

The second cover unit 1200 may include a second inner cover 1210 made of a flexible material to be coupled to the second body of the foldable cell phone 10, a second outer cover 1220 made of a rigid material to maintain a shape of the second inner cover 1210, and a second peripheral part 1230 provided on three edges of the second inner cover 1210 except for a first cover unit-side edge among the four edges. Here, a second opening H2 is provided in each of the second inner cover 1210 and the second outer cover 1220 to expose a rear camera on the rear surface of the second body of the foldable cell phone 10.

### 1.2.1. Second Inner Cover 1210

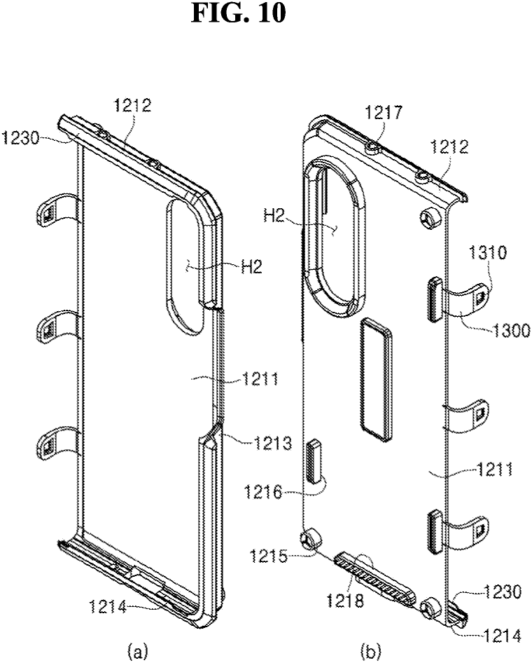

(a) and (b) of FIG. 10 are views illustrating a second inner cover of the second cover unit and a connection unit extending therefrom according to an embodiment of the present disclosure.

Referring to FIGS. 6 and 10, the second inner cover 1210 may include: a second inner cover frame 1211 on which the rear surface of the second body of the foldable cell phone 10 may be seated; a plurality of bent parts 1212, 1213, and 1214 provided on three edges of the second inner cover frame 1211 except for a first cover unit-side edge among the four edges; a plurality of spacers 1215, each of which protrudes rearward from the rim of the rear surface of the second inner cover frame 1211; a plurality of connect slot 1216 and 1218 which are spaced apart from the plurality of spacers 1215 and formed on the rear surface of the second inner cover frame 1211; and a plurality of connect holes 1217 which are formed in the fourth bent part 1212 which among the plurality of bent parts 1212, 1213, and 1214, extends in the front-rear direction Y.

The second inner cover frame 1211 may have a quadrangular frame shape. The second inner cover frame 1211 may have a second opening H2 formed at a predetermined position on the rim. The second inner cover frame 1211 may have an area capable of covering the rear surface of the second body of the foldable cell phone 10. The plurality of bent parts 1212, 1213, and 1214 may be bent from the above-described three edges of the second inner cover frame 1211 in the left-right direction so as to contact the outline of the second body of the foldable cell phone 10. The fifth bent part 1213 among the plurality of bent parts 1212, 1213, and 1214 may extend in the front-rear direction Y, and the sixth bent part 1214 may extend in the up-down direction Z. The plurality of spacers 1215 may pass through the second outer cover 1220 and protrude rearward from the second outer cover 1220. The distances by which the rear ends of the plurality of spacers 1215 protrude from the second outer cover 1220 may be equal to the distance by which the rear camera on the rear surface of the second body of the foldable cell phone 10 protrude rearward from the second outer cover 1220. The plurality of connect slots 1216 and 1218 may be fitted and coupled to a second outer cover frame 1221. The plurality of connect holes 1217 may allow terminals provided on the outline of the second body of the foldable cell phone 10 to be exposed in the up-down direction Z.

### 1.2.2. Second Outer Cover 1220

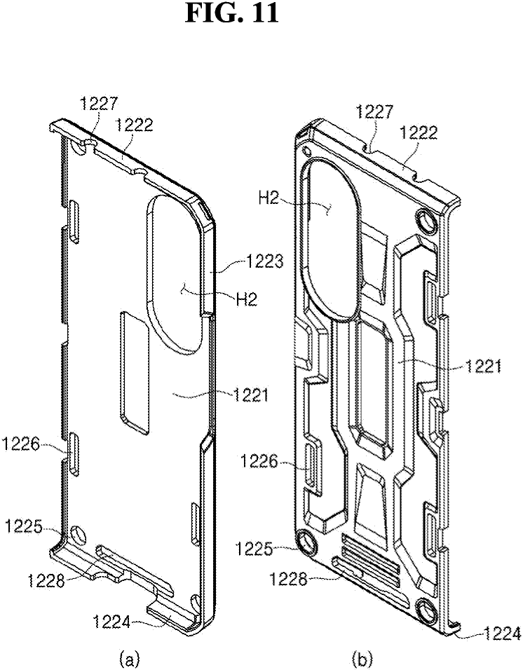

(a) and (b) of FIG. 11 are schematic views of the second outer cover of the second cover unit according to an embodiment of the present disclosure.

Referring to FIGS. 6 and 11, the second outer cover 1220 may include: a second outer cover frame 1221 on which the second inner cover frame 1211 may be seated; a plurality of side walls 1222, 1223, and 1224 provided on three edges of the second outer cover frame 1221 except for a first cover unit-side edge among the four edges; a plurality of spacer holes 1225, which pass through the rim portion of the rear surface of the second outer cover frame 1221 and in which the plurality of spacers 1215 are arranged; a plurality of connect slits 1226 and 1228 which are spaced apart from the plurality of spacer holes 1225 and formed on the rear surface of the second outer cover frame 1221; and a plurality of connect grooves 1227 which are formed in the fourth side wall 1222 which among the plurality of side walls 1222, 1223, and 1224, extends in the front-rear direction Y.

The second outer cover frame 1221 may have the same shape as the second inner cover frame 1211. The second outer cover frame 1221 may have a second opening H2 formed at a predetermined position on the rim portion. The second outer cover frame 1221 may support the second inner cover frame 1211. The plurality of side walls 1222, 1223, and 1224 may be bent from the above-described three edges of the second outer cover frame 1221 in the left-right direction so as to be fitted and coupled to the plurality of bent parts 1212, 1213, and 1214, respectively. The fifth side wall 1223 among the plurality of side walls 1222, 1223, and 1224 may extend in the front-rear direction Y, and the sixth side wall 1224 may extend in the up-down direction Z. The plurality of connect slots 1216 and 1218 may be fitted and coupled to the plurality of connect slits 1226 and 1228, respectively, and the plurality of connect holes 1217 may be fitted and coupled to the plurality of connect grooves 1227.

### 1.2.3. Second Peripheral Part 1230

The second peripheral part 1230 may be formed on ends of the fourth bent part 1212, the fifth bent part 1213, and the sixth bent part 1214. The second peripheral part 1230 may protrude from the ends of the fourth bent part 1212, the fifth bent part 1213, and the sixth bent part 1214 in the up-down direction Z and the front-rear direction Y so as to contact the rim portion of the front surface of the second body of the foldable cell phone 10. As the second peripheral part 1230 is locked to the rim portion of the front surface of the second body of the foldable cell phone 10, the second cover unit 1200 may be coupled to the second body of the foldable cell phone 10.

### 1.3. Connection Unit 1300

Referring to FIGS. 6 and 10, the connection unit 1300 may extend from the first cover unit-side edge of the second inner cover 1211 among the four edges in the left-right direction X. The connection unit 1300 may be made of the same material as the second inner cover 1211. The connection unit 1300 may connect the third cover unit 1400 to the second cover unit 1200.

The connection unit 1300 may be provided in plurality. For example, the number of connection units 1300 may be three. Surely, the above-described number of connection units 1300 is one example, and the number of connection units 1300 may be diverse. The plurality of connection units 1300 may be arrayed along a direction in which the hinge extends, for example, the up-down direction Z. The plurality of connection units 1300 may be arranged between the third cover unit 1400 and the hinge of the foldable cell phone 10 and thus protected from the outside.

### 1.4. Third Cover Unit 1400

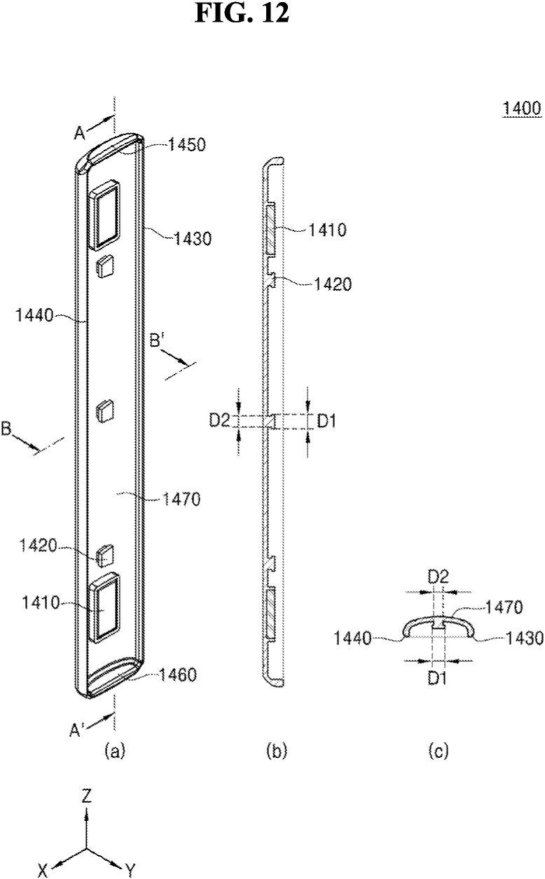

(a), (b), and (c) of FIG. 12 are schematic views of a third cover unit according to an embodiment of the present disclosure.

Referring to FIGS. 6 and 12, the third cover unit 1400 may include: a fixed edge 1430 which extends in the up-down direction Z, in which the hinge of the foldable cell phone 10 extends, and maintains contact with the first cover unit-side edge of the second cover unit 1200 when the foldable cell phone 10 folds and unfolds; a free edge 1440 which extends in the up-down direction Z, contacts the second cover unit-side edge of the first cover unit 1100 when the foldable cell phone 10 folds, and is separated from the second cover unit-side edge of the first cover unit 1100 when the foldable cell phone 10 unfolds; a first connection edge 1450 which connects one end of the fixed edge 1430 and one end of the free edge 1440 in the left-right direction X in which the first cover unit 1100 and the second cover unit 1200 face each other; a second connection edge 1460 which connects the other end of the fixed edge 1430 and the other end of the free edge 1440 in the left-right direction X; and a cover shell 1470 surrounded by the fixed edge 1430, the free edge 1440, the first connection edge 1450, and the second connection edge 1460.

The cover shell 1470 may have an area capable of covering the hinge of the foldable cell phone 10. The cover shell 1470 may be formed such that a central portion of a front surface thereof is recessed in the left-right direction X to accommodate the magnetic member 1410 and the snap member 1420. Each of the magnetic member 1410 and the snap member 1420 may be provided in plurality in the central portion of the front surface of the cover shell 1470. Here, the plurality of magnetic members 1410 and the plurality of snap members 1420 may be arrayed in the up-down direction Z, and the plurality of snap members 1420 may be arranged between the plurality of magnetic members 1410.

The plurality of magnetic members 1410 and the plurality of snap members 1420 may contact the hinge when the foldable cell phone folds, and here, the cover shell 1470 may be attached to the hinge of the foldable cell phone 10 by magnetic force of the plurality of magnetic members 1410. The plurality of magnetic members 1410 and the plurality of snap members 1420 may have lengths not to protrude forward more than the fixed edge 1430 and the free edge 1440 when the foldable cell phone 10 unfolds.

The number of snap members 1420 may be equal to the number of connection units 1300, and the snap members 1420 may be fitted and coupled to the holes 1310 of the connection units 1300. Here, the inner diameter of the hole 1310 of the connection unit 1300 may be less than an end-side diameter D1 of the snap member 1420 of the third cover unit 1400 and greater than or equal to a base-side diameter D2 of the snap member 1420.

As described above, the cover shell 1470 of the third cover unit 1400 may cover the hinge of the foldable cell phone 10 as being attached to the hinge by using a magnetic force of the magnetic member 1410 when the foldable cell phone 10 folds (see FIG. 1), and may cover a gap between the first cover unit 1100 and the second cover unit 1200 as overlapping with the first cover unit 1100 by using an elastic restoring force due to bending deformation of the connection unit 1300 when the foldable cell phone 10 unfolds (see FIG. 3).

The embodiment of the present disclosure has been described above with reference to FIGS. 1 to 12, but the present disclosure includes other embodiments described below and embodied in various manners. These will be described below.

Here, the embodiment of the present disclosure described above is referred to as a first embodiment, and other embodiments described below are referred to as a second embodiment and a third embodiment.

The second embodiment and the third embodiment of the present disclosure will be described below focusing on different feature from the first embodiment of the present disclosure. Also, a similar or identical configuration to the cell phone case according to the first embodiment of the present disclosure will be briefly described, or the description thereof will be omitted.

### 2. Cell Phone Case Capable of Protecting a Hinge According to a Second Embodiment of the Present Disclosure

A cell phone case capable of protecting a hinge according to the second embodiment of the present disclosure is to protect a bendable side surface portion of a foldable cell phone which is used in a state where a first body and a second body are bent to face each other or spread. The cell phone case includes: a rear surface protection unit coupled to at least one of the first body or the second body of the foldable cell phone; and a side surface protection unit connected to the rear surface protection unit to protect a bendable side surface of the foldable cell phone.

The number of rear surface protection unit is one, and may be coupled to the first body or the second body of the foldable cell phone. In this case, the rear surface protection unit may have the same structure as the first cover unit 1100 or have the same structure as the second cover unit 1200.

Also, a plurality of rear surface protection units are provided, and may be respectively coupled to the first body and the second body of the foldable cell phone. In this case, the rear surface protection units may include a first rear surface protection unit and a second rear surface protection unit. Here, the first rear surface protection unit may have the same structure as the first cover unit 1100, and the second rear surface protection unit may have the same structure as the second cover unit 1200.

The rear surface protection unit is provided with a cover connection part having an insertion hole. In a case where two rear surface protection units are provided, the cover connection part may be provided in one of the two rear surface protection units. The cover connection part may have a similar or identical structure to the connection unit 1300. For example, the cover connection part may extend from the first cover unit 1100 or extend from the second cover unit 1200.

The side surface protection unit may have the same structure as the third cover unit 1400. That is, the side surface protection unit includes a snap member to be coupled to the insertion hole of the cover connection part and is connected to the rear surface protection unit. The side surface protection unit may include a side surface connection part attached to and detached from the bendable side surface of the foldable cell phone. The side surface connection part may include a magnetic member to be attached to and detached from the hinge of the foldable cell phone.

### 3. Cell Phone Case Capable of Protecting a Hinge According to a Third Embodiment of the Present Disclosure

The cell phone case capable of protecting a hinge according to the third embodiment of the present disclosure may have a cover connection part having a structure different from that of the cover connection part of the cell phone case capable of protecting a hinge according to the second embodiment of the present disclosure.

The cover connection part of the cell phone case capable of protecting a hinge according to the third embodiment of the present disclosure may be provided in a side surface protection unit. That is, the cover connection part may extend from the side surface protection unit. Here, a rear surface protection unit may include a snap member to be coupled to an insertion hole of the cover connection part.

Meanwhile, the cell phone cases according to the embodiments of the present disclosure described above may have various structures according to the types of foldable cell phones to which the cell phone cases are applied.

That is, the first to third embodiments have been described with regard to the foldable cell phones which may be bent left and right to face each other or spread.

However, the cell phone cases according to the embodiments of the present disclosure may also be applied to foldable cell phones which may be bent up and down to face each other or spread.

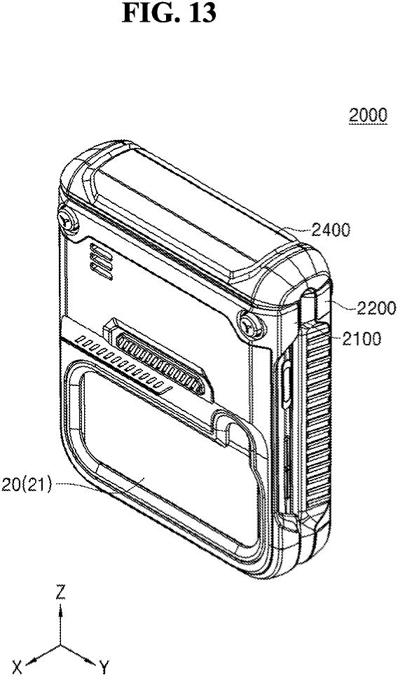

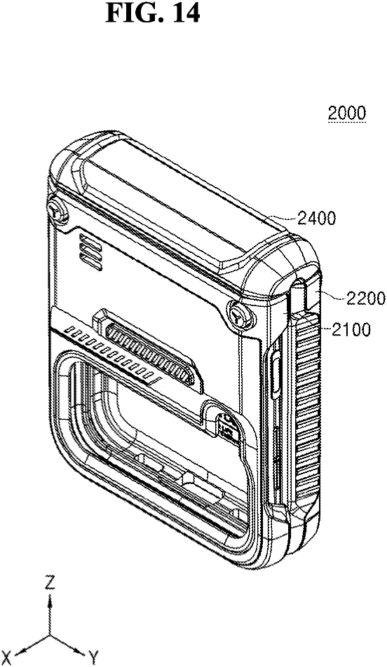

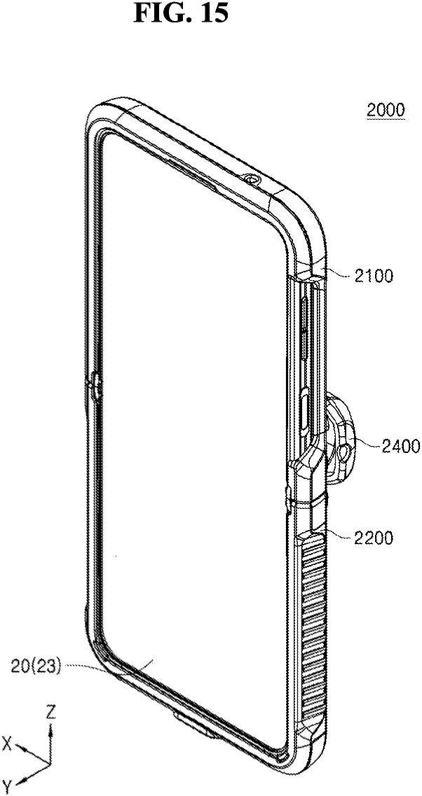

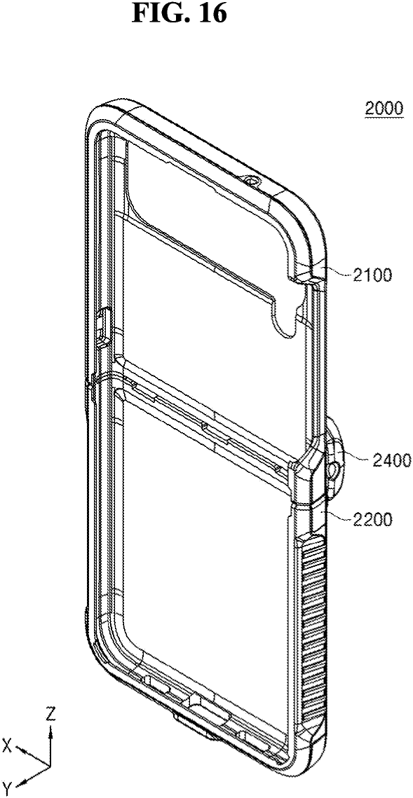

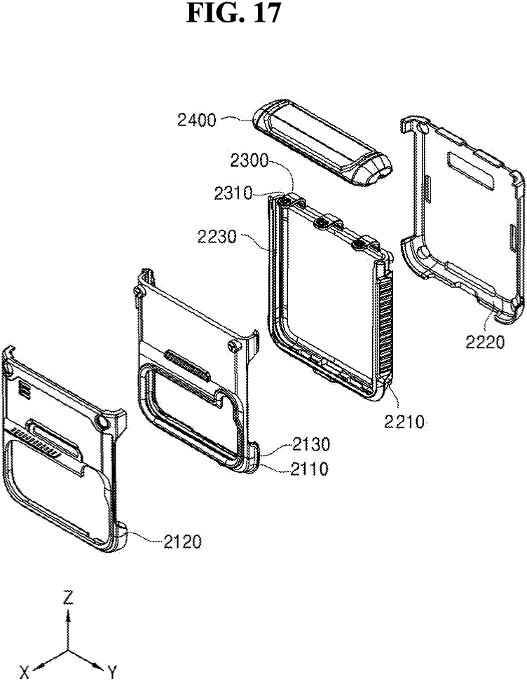

For example, FIGS. 13 to 17 illustrate a cell phone case according to a modified example of the first embodiment of the present disclosure, and the cell phone case may be fitted and coupled to a foldable cell phone which may be bent up and down to face each other or spread.

The structure of the modified example of the first embodiment may also be applied, in the same manner, to the structures of the second embodiment and the third embodiment of the present disclosure.

According to the present disclosure, the embodiment may include the first cover unit coupled to the first body of the foldable cell phone, the second cover unit coupled to the second body of the foldable cell phone and independent from the first cover unit, the third cover unit attached to and detached from the hinge of the foldable cell phone, and the connection unit including the flexible material to enable bending deformation and elastic restoration, extending from the second cover unit, and coupled to the third cover unit.

Through this, the third cover unit maintains the persistent connection to the second cover unit through the connection unit. Accordingly, the third cover unit may be attached to the hinge of the foldable cell phone to protect the hinge of the foldable cell phone when the foldable cell phone folds, and the third cover unit may be detached from the hinge of the foldable cell phone and cover the gap between the first cover unit and the second cover unit to protect the hinge of the foldable cell phone when the foldable cell phone unfolds. Thus, even though a complicated hinge structure is not used, the third cover unit may maintain the connection to the second cover unit all the time and safely protect the hinge of the foldable cell phone depending on circumstances.

The above embodiments of the present disclosure have been made for describing the present disclosure, but are not intended to limit the present disclosure. It should be noted that the configurations and methods disclosed in the embodiments of the present disclosure may be combined and modified into various forms by joining or intersecting same, and these modified embodiments may also be considered within the scope of the present disclosure. That is, the present disclosure may be embodied in various forms within the scope of the claims and the technical ideas equivalents thereto, and it will be understood by those skilled in the art that various embodiments can be made within the scope of the technical ideas of the present disclosure.

1. A cell phone case for protecting a hinge, the cell phone case comprising:
a first cover unit which is provided with a first peripheral part to be coupled to a first body of a foldable mobile phone;
a second cover unit which is provided with a second peripheral part to be coupled to a second body of the foldable mobile phone, faces the first cover unit, and independent from the first cover unit;
a connection unit which comprises a flexible material to enable bending deformation and elastic restoration, extends from a first cover unit-side edge of the second cover unit in a direction in which the first cover unit and the second cover unit face each other, and is provided with a hole at an end thereof; and
a third cover unit which comprises a rigid material to maintain the original form, and is provided with a magnetic member to be attached to and detached from the hinge of the foldable cell phone and a snap member to be coupled to the hole of the connection unit.

2. The cell phone case of claim 1, wherein the first cover unit comprises a first inner cover made of a flexible material to be coupled to the first body and a first outer cover made of a rigid material to maintain a shape of the first inner cover, and
the first peripheral part is provided on three edges of the first inner cover except for a second cover unit-side edge among the four edges.

3. The cell phone case of claim 2, wherein a first opening is provided in each of the first inner cover and the first outer cover to expose an external display on a rear surface of the first body.

4. The cell phone case of claim 1, wherein the second cover unit comprises a second inner cover made of a flexible material to be coupled to the second body and a second outer cover made of a rigid material to maintain a shape of the second inner cover, and
the connection unit extends from a first cover unit-side edge of the second inner cover among the four edges, and the second peripheral part is provided on the remaining three edges except for the first cover unit-side edge.

5. The cell phone case of claim 4, wherein a second opening is provided in each of the second inner cover and the second outer cover to expose a rear camera on a rear surface of the second body.

6. The cell phone case of claim 1, wherein the connection unit is provided in plurality, and the connection units are arrayed along a direction, in which the hinge extends, and protected from the outside by being arranged between the third cover unit and the hinge, and
the number of snap members of the third cover unit is equal to the number of connection units, and the snap members are provided on a front surface of the third cover unit and arrayed along the direction in which the hinge extends.

7. The cell phone case of claim 1, wherein an inner diameter of the hole of the connection unit is less than an end-side diameter of the snap member of the third cover unit and greater than or equal to a base-side diameter of the snap member.

8. The cell phone case of claim 1, wherein the third cover unit comprises:
a fixed edge which extends in a direction, in which the hinge extends, and maintains contact with the first cover unit-side edge of the second cover unit when the foldable cell phone folds and unfolds;
a free edge which extends in the direction, in which the hinge extends, contacts a second cover unit-side edge of the first cover unit when the foldable cell phone folds, and is separated from the second cover unit-side edge of the first cover unit when the foldable cell phone unfolds;
a first connection edge which connects one end of the fixed edge and one end of the free edge in a direction in which the first cover unit and the second cover unit face each other;
a second connection edge which connects the other end of the fixed edge and the other end of the free edge in the direction in which the first cover unit and the second cover unit face each other; and
a cover shell surrounded by the fixed edge, the free edge, the first connection edge, and the second connection edge.

9. The cell phone case of claim 8, wherein the cover shell is formed such that a central portion of a front surface thereof is recessed to accommodate the magnetic member and the snap member.

10. The cell phone case of claim 9, wherein each of the magnetic member and the snap member is provided in plurality, and the magnetic members and the snap members are arrayed in the central portion of the front surface of the cover shell in the direction in which the hinge extends.

11. The cell phone case of claim 10, wherein the plurality of the snap members are arranged between the plurality of the magnetic members.

12. The cell phone case of claim 10, wherein the plurality of magnetic members and the plurality of snap members contact the hinge when the foldable cell phone folds, and have lengths not to protrude forward more than the fixed edge and the free edge when the foldable cell phone unfolds.

13. The cell phone case of claim 10, wherein the cover shell covers the hinge of the foldable cell phone by using a magnetic force of the magnetic member when the foldable cell phone folds, and covers a gap between the first cover unit and the second cover unit as overlapping with the first cover unit by using an elastic restoring force due to bending deformation of the connection unit when the foldable cell phone unfolds.

14. A cell phone case for protecting a bendable side surface portion of a foldable cell phone which is used in a state where a first body and a second body are bent to face each other or spread, the cell phone case comprising:
a rear surface protection unit coupled to at least one of the first body or the second body of the foldable cell phone; and
a side surface protection unit connected to the rear surface protection unit to protect a bendable side surface of the foldable cell phone,
wherein the rear surface protection unit is provided with a cover connection part having an insertion hole, and
the side surface protection unit comprises a snap member to be coupled to the insertion hole of the cover connection part and is connected to the rear surface protection unit.

15. A cell phone case for protecting a bendable side surface portion of a foldable cell phone which is used in a state where a first body and a second body are bent to face each other or spread, the cell phone case comprising:
a rear surface protection unit coupled to at least one of the first body or the second body of the foldable cell phone; and
a side surface protection unit connected to the rear surface protection unit to protect a bendable side surface of the foldable cell phone,
wherein the side surface protection unit is provided with a cover connection part having an insertion hole, and
the rear surface protection unit comprises a snap member to be coupled to the insertion hole of the cover connection part and is connected to the side surface protection unit.

16. The cell phone case of claim 14, wherein the side surface protection unit comprises a side surface connection part attached to and detached from the bendable side surface of the foldable cell phone.

17. The cell phone case of claim 16, wherein the side surface connection part comprises a magnetic member to be attached to and detached from a hinge of the foldable cell phone.
